(19) United States
(12) Patent Application Publication
(10) Pub. No.: US 2012/0298045 A1
(43) Pub. Date: Nov. 29, 2012

(54) ANIMAL FEED AND WATER DISPENSER

(76) Inventor: Lawrence I. Wechsler, Great Neck, NY (US)

(21) Appl. No.: 13/422,440

(22) Filed: Mar. 16, 2012

Related U.S. Application Data
(60) Provisional application No. 61/453,397, filed on Mar. 16, 2011.

(51) Int. Cl. A01K 5/00

(52) U.S. Cl. 119/52.1

(57) ABSTRACT

A dispenser includes a tray containing a pooling space in which contents from a reservoir can be selectively transferred. The reservoir is mountable to the tray, at least in an inactive position, in such manner that the reservoir and tray combination can be selectively oriented in two relative positionings which include the inactive position and a feeding position. The tray is configured to have a longitudinal extent which is coextensive with only a portion of a corresponding longitudinal extent of a particular sized reservoir. The tray includes a proximal end at which the opening of the reservoir is approximately located when in the inactive position, and a distal end spaced apart longitudinally from the proximal end, and which corresponds positionally to a longitudinal position between the reservoir base and the opening thereof when in the inactive (travel/storage) position.

### CROSS REFERENCE TO RELATED APPLICATIONS

This application claims the benefit of U.S. Provisional Application No. 61/453,397 filed Mar. 16, 2011 entitled ANIMAL WATER DISPENSER.

### BACKGROUND OF THE INVENTION

The present invention relates to a portable device for selectively dispensing feed material to animals, and more particularly to a device which is useful for dispensing water, potable liquids, granulated solids and other flowable consumables from a reservoir into a pooling region for consumption thereof.

A device was previously described in U.S. Pat. No. 5,636,592 issued to Wechsler, which includes a trough having a shape allowing at least partial nesting of a suitably configured and sized reservoir therein, which patent disclosure is incorporated herein by reference in its entirety. The reservoir is movable between a first portion and a second position relative to the trough such that when in the first position the reservoir and trough are at least partially nested, and when moved to the second mounted position, the reservoir is brought out of nesting position and is clear of the trough for animal access to contents in the trough selectively transferred thereto from the reservoir.

While providing a particularly compact travel advantage by allowing at least partial nesting of reservoir and trough, the specific disclosed exemplary embodiments of the device referred to above are configured such that the reservoir must be suitably sized and configured to fit within the concavity of the trough. Using the specific disclosed examples as a guide, a user desiring to replace the reservoir with one having a larger volume would be restricted to use of a reservoir which would not exceed the dimensional constraints precursory to enveloped nesting.

Other drinking devices for pets have also been suggested in which a bottle and tray combination is provided, so that the user has at hand a complete feeding system for portable use. However, all of these devices utilize a drinking tray which spans an entirely of the length of the bottle, such that only the bottle specifically intended for use with the dedicated tray can be used. Therefore, a pet owner is not free to select from various bottle sizes having differing volumes as desired based upon the purpose of the outing. For example, for a long hike or full day's outing, a larger bottle size may be warranted, whereas for a short walk, a lighter weight, smaller bottle may be preferred.

It would therefore be desirable to provide a dispenser, from which an animal could be fed water or flowable solids, and which would be adaptable to use with a wide range of differently sized reservoirs (eg., bottles).

Accordingly, it is an object of the invention to provide a feed dispenser for animals, for dispensing water, potable liquids, granulated solids and other flowable consumables for consumption thereof from a drinking tray, from which, for example, water dispensed thereto could be freely lapped or otherwise accessed for consumption, which overcomes the drawbacks of the prior art.

It is a further object of the invention to provide a dispenser capable of administering liquids and flowable solids for consumption, which is portable, and which is versatilely adapted to use with a wide range of bottle sizes and shapes.

It is a still further object of the invention to provide the dispenser in a form which is compact, easy to operate, which may be produced economically, and which is eco-friendly by virtue of reducing the amount of petroleum-based plastics required in its construction, for less impact on the environment.

### SUMMARY OF THE INVENTION

In accordance with these and other objects of the invention, there is provided a dispenser which includes a trough (also referred to synonymously herein as a “tray”) containing a pooling space in which contents from a reservoir can be selectively transferred. The tray is conveniently provided in the form of a generally scoop-shaped tray. A reservoir (conveniently provided in the form of a bottle) is mountable to the tray, at least when oriented in a compact storage/travel, inactive position, in such manner that the reservoir and tray combination can be selectively oriented in two relative positionings, i.e. the inactive position mentioned above, and a feeding position, by detachment and remained separation or subsequent re-attachment of the tray to the reservoir, or by some form of attached movement, for example, hingable movement between the two positions. When in the feeding position, contents expelled from the reservoir are transferred to the pooling space in the trough which is positioned sufficiently clear of the reservoir, either by separation or relative reorientation, to allow animal access to the pooled material in the trough.

In accordance with the invention, the tray is configured to have a longitudinal extent which is coextensive with only a portion of a corresponding longitudinal extent of a particular sized reservoir which runs from an opening in the reservoir to a base thereof, except perhaps in the case of the smallest of several reservoirs adapted for use with the tray. In any event, however, in no case does the tray wrap around a resting surface of a base of the reservoir. The tray includes a proximal end at which the opening of the reservoir is approximately located when in the inactive position, and a distal end spaced apart longitudinally from the proximal end, and which corresponds positionally to a longitudinal position approximately at the reservoir base (for the smallest reservoir) or between the reservoir base and the opening thereof when in the inactive (travel/storage) position.

Advantageously, the tray, and the at least a longitudinal portion of the reservoir which the tray overlays when in the inactive mounted position, have roughly corresponding shapes, such that compact efficiency is achievable by the intentional conformability between the concavity of the pooling region of the tray, and a bulged configuration of the reservoir portion which is coextensive with the tray. General structural conformance between the tray and the bulged portion further enhances the ability of the pooling space to restrain any pooled water or other consumable within its peripheral boundary by providing a sufficiently cup-shaped concavity, and concomitantly, assuring that the tray does not have to significantly protrude radially outward of the reservoir diameter in the region of the tray, when received thereto in the inactive position.

In a particularly advantageous embodiment, the reservoir is provided in the form of a bottle having an opening at one end and a base at an opposed end, the longitudinal extent of the bottle extending therebetween. The bottle is configured to include a tapered or otherwise indented region between the base and the opening, such that the distal end of the tray is received in the tapered region or indentation, and the portion of the bottle extending between the tapered region (indentation) and the bottle opening defines the bulged portion conforming roughly to the form of the concave tray interior. This allows the distal end of the tray to be provided with a retaining wall which inhibits spilling of the pooled contents, while not adversely affecting the compactness of the nesting of the tray with the bottle.

Another advantageous, and particularly eco-friendly embodiment of the invention is directed to a kit comprised of two or more reservoirs of different volumes (with varying diameters and/or lengths) in which each of the reservoirs include a bulged portion of like dimension, such that the same tray can be used with any of the reservoirs. It is noted, in this regard, that the tray can be designed with enough play so as to accommodate a larger diameter bottle is so desired. Whereas, heretofore, a user would need to purchase multiple matched trays and reservoirs to meet changing requirements or preferences of bottle volume, the user purchasing a single tray in accordance with this embodiment of the invention would have the choice of using any suitably sized reservoir without the need to unnecessarily waste resources necessary to fabricate additional trays.

The above, and other objects, features and advantages of the present invention will become apparent from the following description read in conjunction with the accompanying drawings.

### BRIEF DESCRIPTION OF THE DRAWINGS

FIG. 1 is a perspective view of an embodiment of an animal feed/water dispenser in accordance with the invention, shown in an inactive travel/storage position;

FIG. 2 is a grouping of animal feed/water dispensers according to an embodiment of the invention showing the same tray installed to three different size bottles (reservoirs);

FIG. 3 is a cross-sectional side view depicting an embodiment according to the invention which illustrates the general conformance of geometries between a bulged upper bottle portion and an interior of a tray;

FIG. 4 is a cross-sectional view taken along a longitudinal axis of the tray which illustrates the cup shaped concavity in the tray as a result of the configuration of the embodiment of FIG. 3;

FIG. 5 is a perspective view depicting the dispenser of FIG. 1 in an active feeding position;

FIG. 6 is a side elevational view of an alternative embodiment in accordance with the invention;

FIG. 7 is a partial cross-sectional side view depicting an embodiment according to the invention which employs a ball-valve which is operable to automatically open and close when the bottle reservoir is respectively pivoted out of and into a nested orientation with the tray; and

FIG. 8 a grouping of animal feed/water dispensers according to another embodiment of the invention showing the same tray installed to three different size bottles (reservoirs).

### DETAILED DESCRIPTION OF THE PREFERRED EMBODIMENT

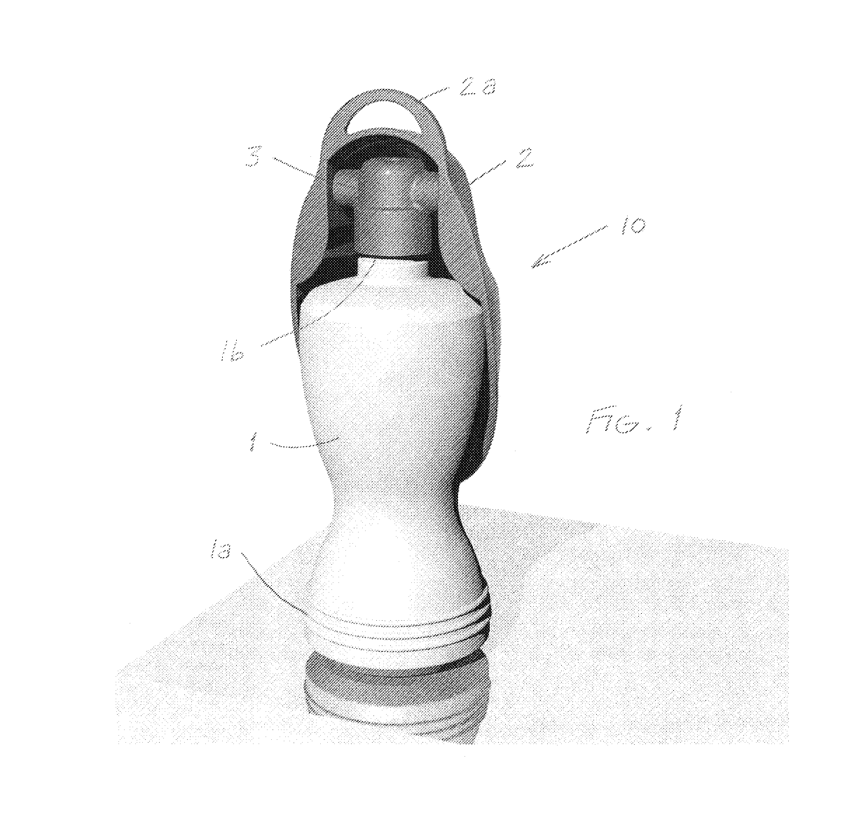

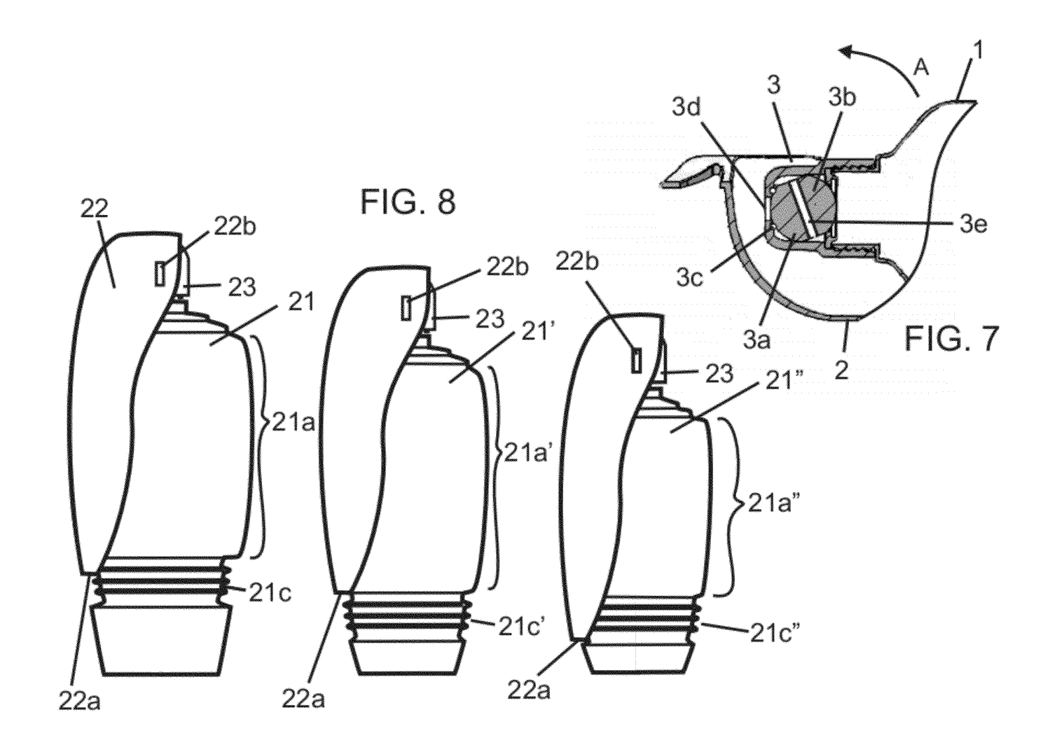

Referring now to the figures, and in particular FIG. 1, a dispenser for feeding animals (pets) water or other flowable substances is shown generally at 10. The dispenser 10 includes a reservoir, provided in the form of a bottle 1, and a tray 2 having a concavity which serves as an open top receptacle for receiving water transferred there from reservoir 1 via a valve 3. The details of the particular valve 3 shown is considered unnecessary for the disclosure of the invention, which serves as an improvement to prior patent disclosure U.S. Pat. No. 5,636,592, the entirety of which is incorporated herein by reference. In practice, however, a ball valve of conventional design is advantageously employed, and which automatically opens when the valve seat portion is rotated along with a reorientation of the bottle 1 relative to the tray 2 from a closed (inactive) position to an active feeding orientation, and the tray and valve ball element are held in fixed relationship to one another. This valve example is described with reference to FIG. 7 below herein.

Bottle 1 advantageously includes a grip 1a and a threaded neck portion 1b at an opening thereof to permit threaded connection of the bottle 1 with valve 3. Tray 2 optionally includes a loop 2a to permit tethered connection to a hang clip or shoulder strap.

As described above, because of the configuration of the tray as shown and described, a same tray can be used for a wide range of bottle sizes, so as to permit one tray and a multitude of bottles to be used together, obviating the need for a consumer to purchase separate bottle/tray combinations in order to have at hand various desired feed/water capacities for particular circumstances, and thereby conserving valuable resources.

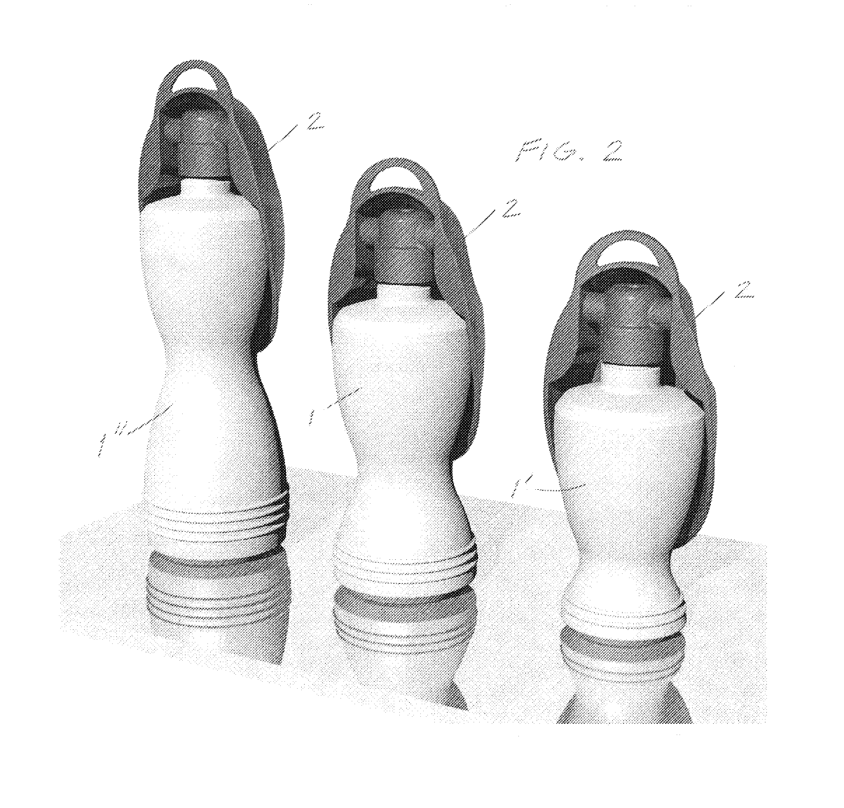

FIG. 2 depicts identical trays 2 (more specifically, tray/valve assemblies 2, 3) mounted to three different volume capacity bottles 1, 1′, 1″. While three tray/valve assemblies 2, 3 are shown for illustration purposes, it will be understood that the user may simply use a single tray/valve assembly and any selected one of the bottles 1, 1′, 1″ (or selected from even more bottles than the three sizes shown).

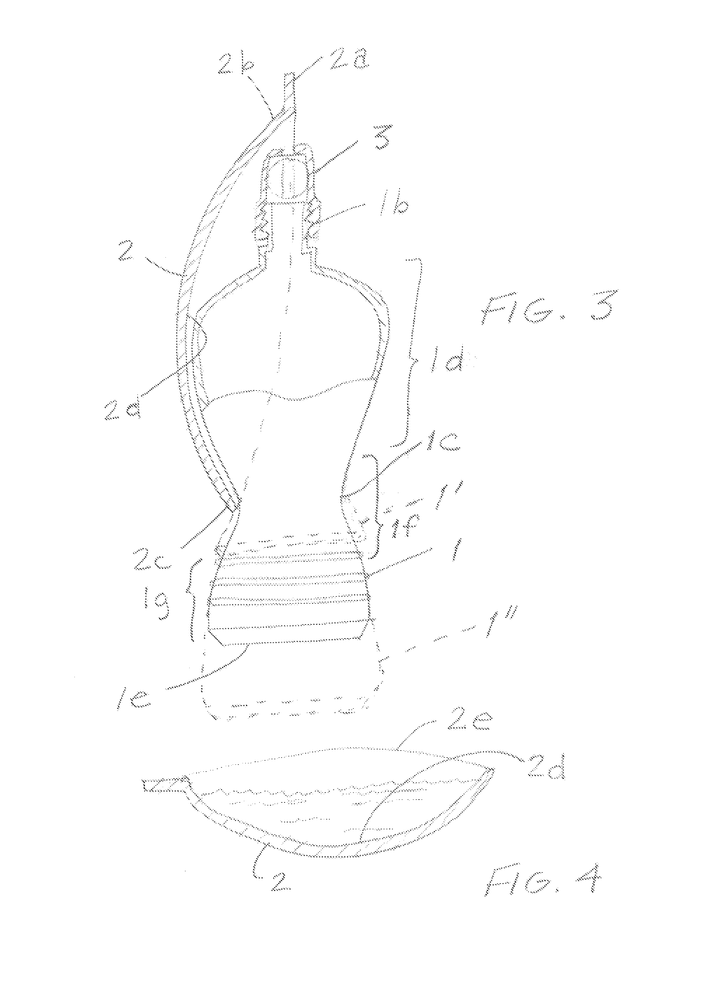

Turning now to FIGS. 3 and 4, the tray 2 is shown to be configured to have a longitudinal extent which is coextensive with only a portion of a corresponding longitudinal extent of a particular sized reservoir (bottle 1 in the depicted example) which runs from an opening (generally at 1b) in the bottle 1 to a base 1e thereof, except perhaps the smallest of several bottles adapted for use with the tray 2, since this will not impede use of the tray on larger bottles. The tray 2 includes a proximal end 2b at which the opening of the bottle 1 is located when in the inactive position (as depicted in FIG. 3), and a distal end 2c spaced apart longitudinally from the proximal end 2b, and which corresponds positionally to a longitudinal position 1c between the reservoir base and the opening thereof when in the inactive (travel/storage) position.

Advantageously, although not necessarily, the tray 2, and the at least a portion of the bottle 1 which the tray 2 overlays when in the inactive mounting position, have corresponding shapes, such that compact efficiency is achievable by the intentional conformability between the concavity 2d of the pooling region of the tray 2, and a bulged configuration of the bottle portion 1d which is coextensive with the tray 2. General structural conformance between the tray 2 and the bulged portion 1d further enhances the ability of the tray concavity 2d to restrain any pooled water within its peripheral boundary 2e by providing a sufficiently cup-shaped concavity 2d, and concomitantly, assuring that the tray 2 does not have to significantly protrude radially outward of the bottle diameter in the region of the tray 2, when received thereto in the inactive position, as clearly depicted in FIG. 3.

In accordance with the particularly advantageous embodiment shown in FIG. 3, the bottle 1 includes the opening at the threaded neck 1b end and a base 1e at an opposed end, the longitudinal extent of the bottle extending therebetween. The bottle 1 is configured to include a tapered region 1f between the base 1e and the threaded neck 1b, such that the distal end 2c of the tray 2 is received in the tapered region 1f, and the portion of the bottle 1 extending between the tapered region 1f and the threaded neck 1b defines the bulged portion 1d conforming roughly to the form of the concave tray interior 2d.

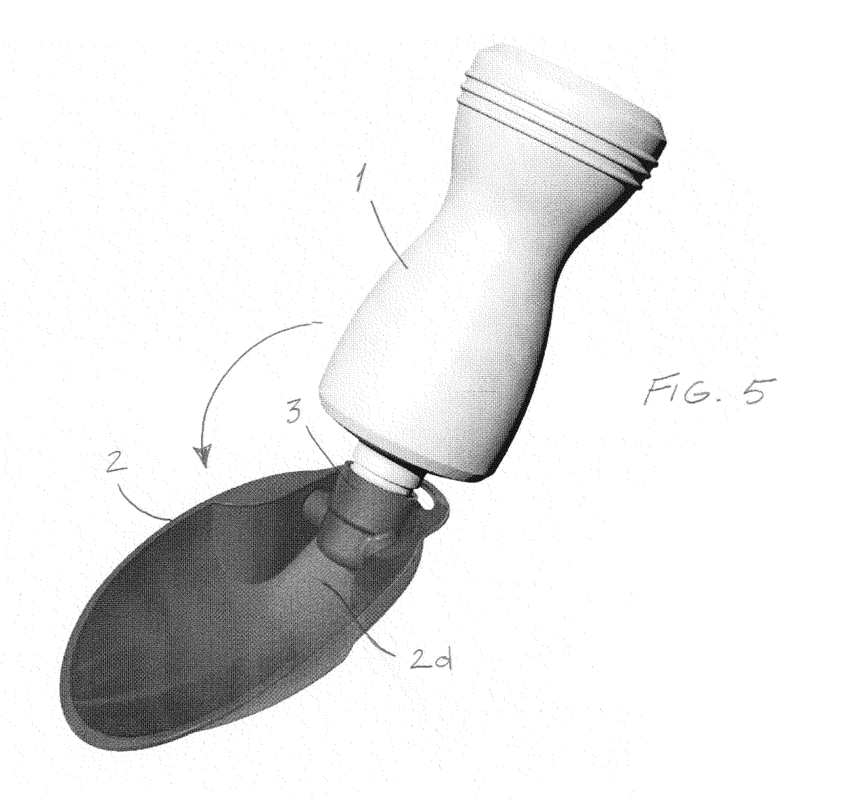

In the particularly advantageous embodiment depicted by example in the figures, the dispenser is operated simply by pivoting the tray 2 away from the bottle 1, and into the active use position as shown in FIG. 5, in which water/feed can be readily transferred to the tray 2 by operation of gravity or by some form of forcible or selectively initiated expulsion from the bottle 1.

A particularly advantageous embodiment shown in FIG. 7 utilizes a ball valve which automatically opens and closes which the tray and bottle are reoriented. Valve 3 includes a seat portion 3a and a captive ball element 3b sealed by an o-ring 3c about an opening 3d in the seat portion 3a. A passage 3e is provided through the ball element 3b which aligns with the bottle opening and the opening 3d when the bottle 1 is pivoted in the direction of arrow A out of a nested travel/storage orientation, and allows flow of the consumable to be initiated from the bottle into the tray via passage 3e.

However, it is to be understood that, inasmuch as the invention is directed to an intentionally co-related configuration of tray and reservoir, which provides particular advantage over the prior art as described herein, and not to any precise structural or operational manner of reorienting the tray from a mounted position, with the bottle in the inactive position, to the active position (whereat the tray is either attached or detached from the bottle or bottle/valve), the invention is not intended to be limited to the details of the preferred embodiment, and any suitable mechanism permitting this relative reorientation is contemplated within the scope of the invention. This will even include physical detachment and separation of the tray from the bottle for movement between nested and active feeding positions, and subsequent re-attachment of the tray to the bottle when a particular orientation is selected. Cooperative structure for achieving a removable snap-together union carried on the bottle and the tray when located in the two orientations, the details of which are well know to those skilled in the art, will easily allow this attachment and re-attachment operation when such embodiment is employed in place of an attached movement between active feeding and inactive travel orientations of the tray and bottle. Further, the tray can even remain detached from the bottle for active feeding, and need only be advantageously assembled to the tray for nested storage/travel. Similarly, the provision of a valve is deemed optional. For example, the valve could be omitted, and the bottle outlet could be sufficiently restricted to require forceable squeezing of the bottle to expel consumables.

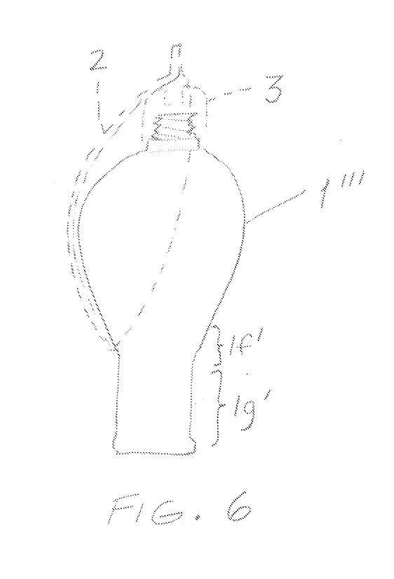

Additionally, while the bottle 1 of FIGS. 1-3 and 5 is configured to include a flared base region 1g below the tapered region 1f for better hand gripping and superior balance when rested on a support surface, thereby defining the appearance of a “waist,” alternative base portions are contemplated without departure from the invention. For example, as shown in FIG. 6, a bottle 1″ includes a base portion 1g′ which is simply a longitudinal extension of the tapered portion 1f′.

FIG. 8 depicts an additional alternative embodiment according to the invention, in which identical trays 22 (more specifically, tray/valve assemblies 22, 23) are shown mounted to three different volume capacity bottles 21, 21′, 21″. While three tray/valve assemblies 22, 23 are shown for illustration purposes, it will be understood that the user may simply use a single tray/valve assembly and any selected one of the bottles 21, 21′, 21″ (or selected from even more bottles than the three sizes shown).

Bottles 21, 21′, 21″ which serve as reservoirs for containing the consumable material (for example, water), differ in shape from bottles 1, 1′, 1″ of the embodiment of FIG. 2, but nevertheless advantageously utilize a bulged region 21a, 21a′, 21a″ which protrudes radially into a space defined at least by a concavity in the tray 22 in which the consumable material can be made to pool. At least one groove (a series of grooves 21c, 21c′, 21c″ being shown in the depicted embodiment of FIG. 8) serve(s) an analogous function with tapered region 1f described with reference to FIG. 3, similarly allowing the distal end (at 22a) of tray 22 to be received in the at least one groove 21c, 21c′, 21c″. Such configuration facilitates, in a compact fashion, providing the tray 22 with an upright wall at the distal end 22a thereof, to allow improved retention of the consumable material within the tray 22 when the same is transferred thereto for consumption by the animal. Tray 22 includes a slot 22b in which an extension of the ball element 3b (see FIG. 7) is retained to prevent rotation thereof relative to the tray 22, to permit valve operation as described above, when such embodiment is optionally utilized.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A dispenser for dispensing consumable material to an animal, comprising:
a reservoir in which a supply of the consumable material is containable, said reservoir having an opening through which the consumable material can pass; and
a tray including a concavity at least partially defining a space in which at least a portion of the consumable material can be retained for presentation to the animal when the space in the tray is brought into selectable communication with an outlet of the reservoir, said concavity being coextensive with only a portion of a longitudinal extent of said reservoir, said portion including a region which protrudes radially into said space defined at least by said concavity.

2. A dispenser kit, comprising:
at least two reservoirs of differing dimension, each in which a supply of a consumable material is containable, said at least two reservoirs each having an opening through which the consumable material can pass; and
a tray including a concavity at least partially defining a space in which at least a portion of the consumable material can be retained for presentation to the animal when the space in the tray is brought into selectable communication with an outlet of the reservoir, said concavity being coextensive with only a portion of a longitudinal extent of said reservoir, said portion including a region which protrudes radially into said space defined at least by said concavity, said tray being accommodated on a selected one of said at least two trays for use.
